(19) United States
(12) Patent Application Publication
(10) Pub. No.: US 2024/0078565 A1
(43) Pub. Date: Mar. 7, 2024

(54) SYSTEMS AND METHODS FOR GENERATING DYNAMIC TRANSACTION DATA

(71) Applicant: U.S. Bancorp, National Association, Minneapolis, MN (US)

(72) Inventors: Giacomo Domeniconi, New York, NY (US); Kai-min Kevin Chang, San Mateo, CA (US); Samuel Assefa, Watertown, MA (US)

(21) Appl. No.: 18/153,909

(22) Filed: Jan. 12, 2023

Related U.S. Application Data
(60) Provisional application No. 63/404,358, filed on Sep. 7, 2022.

(51) Int. Cl. G06Q 30/0202; G06N 20/00

(52) U.S. Cl. CPC G06Q 30/0202; G06N 20/00

(57) ABSTRACT

A data processing system may generate a plurality of probability distributions, each probability distribution corresponding to a different profile characteristic regarding transactions performed by an entity. The data processing system may receive a first profile characteristic configuration for each of the plurality of probability distributions and a corresponding first start time. The data processing system may adjust each of the plurality of probability distributions according to the first profile characteristic configuration for the probability distribution and the first start time to generate a first set of adjusted probability distributions. The data processing system may sample each of the first set of adjusted probability distributions to generate transaction data for one or more first transactions. The data processing system may generate a record comprising the generated transaction data.

### CROSS-REFERENCE TO RELATED APPLICATION

This application claims the benefit of priority to U.S. Provisional Application No. 63/404,358, filed Sep. 7, 2022, the entirety of which is incorporated by reference herein.

### BACKGROUND

The proliferation of storage and network devices enables a large amount of data to be exchanged and stored. A large amount of data allows analysis or predictions that were not feasible before. For example, a big data analysis performed on millions of accounts may enable online behavior predictions of consumer behavior.

In some instances, a company entity may wish to train a machine learning model to identify individuals that will likely leave the company or stop using the company's products. Training a machine learning model to identify such individuals may require transaction data about the individuals from which the model may identify patterns within the data. If individuals perform transactions in a manner similar to the performed transaction patterns, the processor may flag the individuals with the matching patterns as potential candidates to stop using the financial company's products. However, real-world financial data often suffers a number of different challenges, which inhibits their usage in tasks involving machine learning (e.g., to train a machine learning model). For instance, such challenges may include, security and privacy constraints established by law, which limit the context and scope of any use of users' financial data. As another example, such challenges can include limited quantities/size of available datasets for one or more consumers' financial transactions. In addition, there may be limits on what is known about, or available information regarding, the transaction datasets that are available (e.g., lacking known labels for real-world transaction data).

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is an illustration of a system for generating transaction data for one or more transactions, according to one implementation.

FIG. 2A is an illustration of a method for generating transaction data, according to one implementation.

FIG. 2B is an illustration of a method for generating transaction data to train a machine learning model, according to one implementation.

FIG. 3 is an illustration of a sequence for generating a profile characteristic configuration for a plurality of probability distributions, according to one implementation.

FIG. 4 is an illustration of a sequence for generating transaction data for one or more transactions according to one or more profile characteristic configurations for a plurality of probability distributions, according to one implementation.

FIG. 5A is an illustration of a plurality of probability distributions, according to one implementation.

FIG. 5B is an illustration of a plurality of probability distributions, according to one implementation.

FIG. 6A is an illustration of transaction data for a plurality of transactions occurring within a specified period of time, according to one implementation.

FIG. 6B is an illustration of transaction data for a plurality of transactions occurring within a specified period of time, according to one implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As previously mentioned, the amount of data that is required to train machine learning models to identify a change in customers' spending behaviors can require a large amount of information that is difficult to obtain and/or is simply unavailable due to a lack of data regarding customers' spending. The lack of available real-world data regarding customers' spending is, therefore, a major challenge in development of machine learning models that can detect patterns within, or changes to, the transaction data of financial institutions. For example, real-world financial consumer data is often unavailable for use in training machine learning models due to the confidential nature of such data (e.g., because of regulations restricting the permissible uses of consumers' financial transaction data), an inadequate amount of data regarding consumers' transactions, and the limited knowledge regarding the available data (e.g., the lack of transaction data for which the applicable changes are already known to use in training a machine learning model to identify similar changes in other datasets).

For example, each of the aforementioned challenges are currently present in attempting to develop machine learning models capable of analyzing a transactional, time-series data for a user's spending behaviors that change over time. Upon certain events (e.g., a stolen credit card, a change in primary banks, a change in employment status), users' spending behaviors may change or exhibit differing patterns than were previously present in the users' spending before such an event had occurred. The ability to successfully detect these and similar events, which are associated with changes in users' spending behaviors, is important in training machine learning models to generate account prediction values (e.g., potentially fraudulent transactions, likely attrition of one or more consumers, forecasting consumers' cash flow, etc.).

Implementations of the systems and methods discussed herein overcome these technical deficiencies because they provide a method and a model architecture that can generate (e.g., simulate) transaction data for one or more transactions for account behavior (e.g., performed transactions) that changes over time. For example, a computer implementing the systems and methods discussed herein may generate transaction data for one or more transactions, which transaction data can be used to train a machine learning model to generate an account prediction value based on the generated transaction data. The computer can make random perturbations to a set of probability distributions and generate one or more sets of adjusted probability distributions by randomly perturbing one or more adjusted probability distributions of a set of adjusted probability distributions (e.g., generating a second set of adjusted probability distributions by randomly perturbing a first set of adjusted probability distributions, generating a third set of adjusted probability distributions by randomly perturbing the second set of adjusted probability distributions, etc.). The computer can generate any number of sets of adjusted probability distributions in this manner (e.g., generating a randomly determined number of sets of adjusted probability distributions that can be any number in the range defined by a minimum number of sets of adjusted probability distributions and a maximum number of sets of adjusted probability distributions). Alternatively, or in addition, the computer may generate one or more adjusted probability distributions. The adjusted probability distributions can be sampled to generate transaction data for a set of transactions that reflect a consumer's dynamic (e.g., changing) spending behaviors over time. The changes in the generated transaction data is, therefore, known, and those known changes present in the generated transaction data can be used to train one or more machine learning models to recognize similar changes in other (e.g., real-world) transaction data.

In addition, the generated transaction data can include specific events or types of transactions for use in training machine learning models to identify such events. For example, a computer implementing the systems and methods discussed herein may generate a labeled training data set, or a labeled copy of the transaction data of one or more transactions generated using one or more distribution modifiers, which may be used to train one or more machine learning models to identify the same, or similar, conditions in other, unlabeled or real-world, transaction data. Alternatively, or in addition, a computer implementing the system and methods discussed herein may generate transaction data that includes one or more fraudulent transactions or to generate transaction data for customers subject to attrition (e.g., customers that will ultimately close an account or for whom spending will eventually cease altogether).

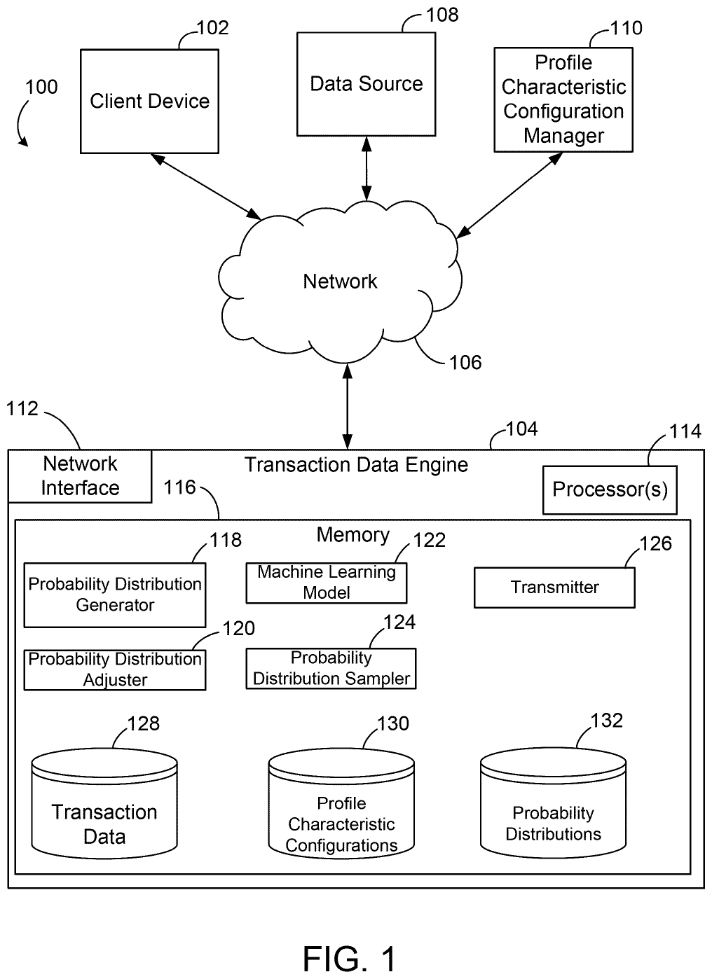

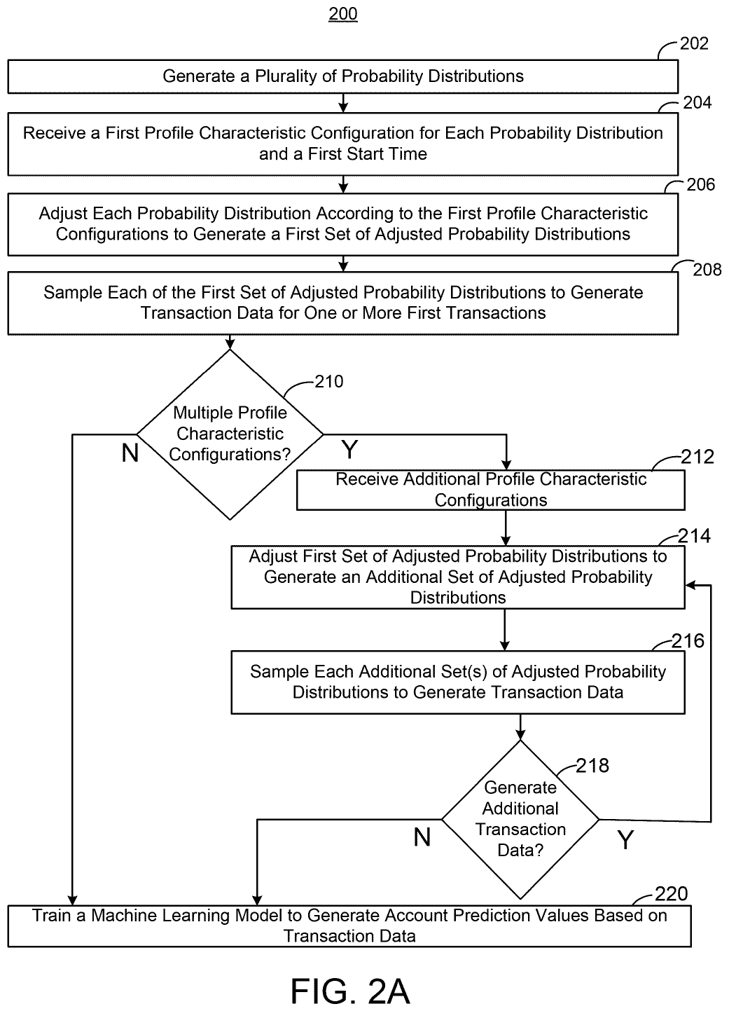

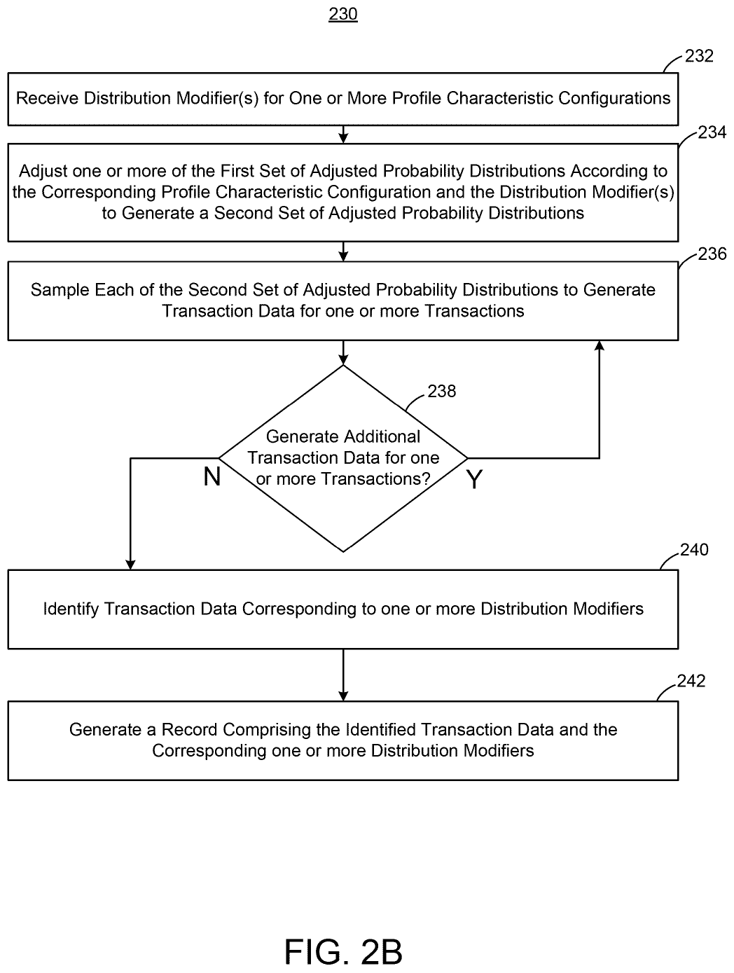

Implementations of the systems and methods discussed herein may generate transaction data for one or more entities (e.g., one or more simulated customers, accounts, etc.) using a configuration (e.g., one or more profile characteristic configurations, described below with reference to FIGS. 1, 2A, 2B, etc.), or configuration data, which comprises parameters (e.g., a plurality of profile characteristics and associated information, such as start times and the like) to define the transaction data to be generated for one or more transactions (e.g., parameters that define a synthetic dataset of transaction data and generates the same). In some embodiments, a configuration may be derived from transaction data collected from real-world transactions by one or more customers. Alternatively, or in addition, in some embodiments, the configuration data may be based on transaction data for one or more ‘synthetic’ or simulated transactions, which may be generated by a computer program, an artificial intelligence, or the like, instead of transaction data from one or more real-world transactions.

In some embodiments, the configuration data may comprise information or parameters for generating transaction data, such as parameters defining the number of entities for which transaction data will be generated based on the configuration data. For example, the configuration data may comprise a parameters for a number of customers and a number of one or more accounts per customer, which may cause transaction data for one or more transactions to be generated for that number of accounts for each of the specified number of customers (e.g., defining the scope of transaction data that are, or that will be, stored in a database). In some embodiments, such transaction data may comprise a plurality of different transactions by each account for each customer.

Additionally, in some embodiments, the configuration data may further comprise parameters or attributes for each account and/or each customer for which transaction data may be generated. For example, the configuration data may comprise a period of time (e.g., a date interval or duration) for which transaction data may be generated, a minimum and a maximum number of profile characteristic configurations to generate and/or receive, which may be used to generate transaction data for one or more transactions, a minimum and a maximum number of profile characteristics that may change between two different profile characteristic configurations (e.g., compared to a current or active profile characteristic configuration), a probability distribution (e.g., an unadjusted probability distribution or base distribution) for an amount (e.g., a value) of a transaction for which transaction data may be generated, a probability distribution for a number of transactions that may occur (e.g., for which transaction data may be simulated) per each time interval (e.g. per day) within the period of time or duration (e.g., a probability distribution for a number of transactions by a customer, and for which transaction data may be generated, per day), a probability distribution of a number of recurrent transactions (e.g., a transaction that occurs with a defined frequency, such as on an annual, monthly, or weekly basis), spending categories, or merchant codes, assigned to each transaction, a number of preferred spending Merchant Category Codes (or MCCs), or merchant codes, one or more locations (e.g., one or more countries, counties, cities, and/or zip codes) used to determine a location for the one or more transactions when generating the transaction data. As can be appreciated, any or all of the above parameters of the configuration data, including others not expressly listed above, may be derived from available real-world data (e.g., transaction data for transactions by existing accounts) and/or from data that is simulated, synthetic, and/or generated by a computer or other means.

In some embodiments, implementations of the systems and methods described herein may comprise a set of processes that, given a set of configuration parameters (e.g., configuration data), generate a set of customers, for which transaction data may be generated. For each customer, one or more spending profiles (e.g., one or more profile characteristic configurations) may be generated (of which the number may be randomly defined) of spending profiles. Each spending profile may be defined with a set of features, such as, but not limited to a starting date or specified period of time for that spending profile is active, a probability distribution of transactions per time interval (e.g., transactions that may occur per day), a probability distribution of an amount per transaction (e.g., possible dollar values per transaction), a probability distribution of recurrent transactions (e.g., a transaction with at least a specified amount, which occurs according to a known frequency such as every year, month, week, etc.), one or more merchant category codes (e.g., one or more preferred categories of transaction), a probability distribution of one or more locations (e.g., a zip code with transactions occurring at locations based on a distance from the zip code).

For example, in some embodiments a starting date of a spending profile, or a set of profile characteristic configurations, may be determined by randomly sampling a date within the time interval that defines the duration of the transaction data to be generated (e.g., a time interval or duration from the configuration data). The probability distributions for the number of transactions per day, the amount per transaction, and one or more recurrent transactions may be generated as randomly perturbed versions of the corresponding probability distributions provided in the configuration data (e.g., one or more base distributions). In some embodiments, the merchant category codes for a spending profile may be a random subset of one or more available merchant category codes (or merchant codes). The random selection of the merchant category codes may follow a probability distribution retrieved by real data and provided in the configuration data. Additionally, in some embodiments, the location for a spending profile may be defined as a latitude and a longitude, a city, and/or a zip code, with a defined radius (or defining any other shape) of possible locations.

In some embodiments, after the spending profiles of each entity (customer) have been generated, a set of transactions or transaction data may be generated for each entity. As described in greater detail below, the generation of transaction data for each entity may comprise repeated execution, or loop, for each unit of time (e.g., each hour, number of hours, day, number of days, etc.) for which transaction data may be generated, which may be based on the spending profile that is ‘active’ (e.g., with the most recent starting date) at that moment in the duration of the transaction data (e.g., the period of time from the configuration data). At each unit of time (e.g., on each day), a probability distribution for the possible number of transactions may be used (e.g., sampled) to randomly determine a number of transactions to be generated for that unit of time. For a given unit of time (e.g., a given day within the calendar period over which transaction data will be generated), the number of transactions of the transaction data may be zero or any non-negative integer (e.g., any positive whole number, including zero), which defines how many transactions will occur on, or the amount of transaction data to be generated for, that unit of time. After the number of transactions is determined for a given unit of time, a transaction amount (e.g., a dollar value) is determined for each of the transaction(s) for each of the determined number of transactions on that unit of time (e.g., a dollar value of every transaction, for the determined number of transactions in the transaction data for that day). For example, the amount of each transaction is generated for each transaction determined to occur on that unit of time, which may be determined via a random, or semi-random, sampling of a probability distribution of different possible amounts and their respective probabilities (e.g., randomly sampling a Gaussian distribution of transaction amounts or the like). For example, the amounts for each of the transactions to be generated for a given day may be determined via random sampling of an adjusted probability distribution (e.g., a first adjusted probability distribution defined by a minimum possible amount, a maximum possible amount, a median amount, and a standard deviation of possible amounts) by adjusting an existing probability distribution.

Additionally, the one or more merchant category codes may be used to determine a single merchant category code of each transaction. Alternatively or in addition, a probability distribution may be used (e.g., sampled) to determine whether to generate a merchant category code from a set of non-preferred merchant category codes. In some embodiments, the location for a spending profile (e.g., one or more preferred, or likely, locations) may be used to generate a specific location (e.g., county, zip code, city, etc.) for each of the one or more transactions. Alternatively, or in addition, the location for a spending profile, or for individual transactions, may indicate whether a transaction corresponds to a transaction that occurred online (e.g., via the internet) or in-store (e.g., an in-store purchase).

Additionally, some embodiments of the system may determine if the current time interval (e.g., the current date for which transaction data will be generated) matches a condition for one or more recurrent transactions to occur (e.g., whether a recurrent transaction may occur that day) and such recurrent transaction may be generated and added to the set of other transactions generated for that entity.

As described above, implementations of the systems and methods described herein may inject known events or behaviors (e.g., attrition or account termination, one or more fraudulent transactions, etc.) into the transaction data of one or more entities. Injecting events into transaction data of a customer, for example, may facilitate the use of such transaction data to train one or more machine learning models to identify those events in the transaction data. For example, an event that may be injected into transaction data of a customer may comprise one or more transactions that qualify as a ‘fraudulent’ transaction, such as, based on the amount associated with each transaction, a number of transactions occurring per day, a location of a transaction (e.g., transactions in a specified country or outside of a specified region, etc.), which may each be outside of the corresponding probability distribution(s) of the spending profiles for that entity. Alternatively, or in addition, an attrition (e.g., churn, account termination, etc.) event may be injected into the transaction data of an entity. For example, in some embodiments, an attrition event may be injected into transaction data, such that, with each change in the active spending profile for an entity (e.g., at each start time of a spending profile), the number of transactions (e.g., per day or per spending profile) and/or the transaction amounts (e.g., individually or in the aggregate) may be required to decrease compared to the transaction data that was generated for the previous spending profile.

FIG. 1 illustrates an example system 100 for generation of transaction data, in some embodiments. In brief overview, the system 100 can include a client device 102 that communicates with a transaction data engine 104 over a network 106. The transaction data engine 104 can communicate with a data source 108 over the network 106 to generate transaction data for one or more transactions. The transaction data engine 104 can communicate with a profile characteristic configuration manager 110 by receiving one or more profile characteristic configurations from the profile characteristic configuration manager 110. System 100 may include more, fewer, or different components than shown in FIG. 1. For example, there may be any number of client devices, computers that make up or are a part of the transaction data engine 104, or networks in the system 100.

The client device 102 and/or the transaction data engine 104 can include or execute on one or more processors or computing devices and/or communicate via the network 106. The network 106 can include computer networks such as the Internet, local, wide, metro, or other area networks, intranets, satellite networks, and other communication networks such as voice or data mobile telephone networks. The network 106 can be used to access information resources such as web pages, websites, domain names, or uniform resource locators that can be presented, output, rendered, or displayed on at least one computing device (e.g., client device 102), such as a laptop, desktop, tablet, personal digital assistant, smartphone, portable computers, or speaker. For example, via the network 106, the client device 102 can request for an account prediction value for an account with data stored in memory of the transaction data engine 104.

The client device 102 and/or the transaction data engine 104 can include or utilize at least one processing unit or other logic devices such as a programmable logic array engine or a module configured to communicate with one another or other resources or databases. The components of the client device 102 and/or the transaction data engine 104 can be separate components or a single component. The system 100 and its components can include hardware elements, such as one or more processors, logic devices, or circuits.

The transaction data engine 104 may comprise one or more processors that are configured to implement a multi-model architecture to generate transaction data (e.g., synthetic transaction data) for one or more transactions. The transaction data engine 104 may comprise a network interface 112, a processor 114, and/or memory 116. The transaction data engine 104 may communicate with the client device 102, the data source 108, and/or the profile characteristic configuration manager 110 via the network interface 112. The processor 114 may be, or include, an ASIC, one or more FPGAs, a DSP, circuits containing one or more processing components, circuitry for supporting a microprocessor, a group of processing components, or other suitable electronic processing components. In some embodiments, the processor 114 may execute computer code or modules (e.g., executable code, object code, source code, script code, machine code, etc.) stored in the memory 116 to facilitate the activities described herein. The memory 116 may be any volatile or non-volatile computer-readable storage medium (e.g., a non-transitory computer-readable storage medium) capable of storing data or computer code.

In one embodiment, the memory 116 may include a probability distribution generator 118, a probability distribution adjuster 120, a machine learning model 122, a probability distribution sampler 124, a transmitter 126, transaction data database 128, profile characteristic configurations database 130, and a probability distribution database 132. In brief overview, the components 118-132 may cooperate to generate transaction data (e.g., synthetic transaction data) for one or more transactions (e.g., one or more simulated transactions) for each of one or more entities, with the number of entities determined, at least in part, from the one or more profile characteristic configurations stored in the profile characteristic configuration database 130 or retrieved from the memory 116 of the transaction data engine 104. After the transaction data has been generated it may be stored in, or added to, one or more datasets of one or more transactions, may be generated previously and may also be stored in the transaction data database 128.

The components 118-132 may generate transaction data for an entity (e.g., a simulated customer and/or a simulated account), for example, by generating a set of base probability distributions. The components 118-132 may generate one or more adjusted probability distributions (e.g., using random, or semi-random, perturbations) by adjusting one or more of the probability distributions previously output by the probability distribution generator 118. The components 118-132 can then sample the adjusted probability distributions to generate transaction data for one or more transactions associated with the entity.

The probability distribution generator 118 may comprise programmable instructions that, upon execution, cause the processor 114 to generate one or more probability distributions (e.g., a set of one or more base probability distributions) that each correspond to a profile characteristic (e.g., number of transactions per day, value per transaction, transaction location, etc.) and that may be sampled to generate transaction data of one or more transactions by an account. The one or more probability distributions generated by the probability distribution generator 118 may comprise (and may also be referred to as) one or more initial probability distributions, one or more unadjusted probability distributions, and the like. The probability distribution generator 118 may generate a plurality of probability distributions that may be sampled to randomly, or semi-randomly, determine each of the different parameter values of the one or more transactions generated as transaction data. The probability distributions output by the probability distribution generator 118 may each correspond to different parameters of the transaction data to be generated. For example, one probability distribution may correspond to the number of transactions per day, another probability distribution may correspond to amounts for the transactions, and still another probability distribution may correspond to the locations for the transactions.

Alternatively, or in addition, the probability distribution generator 118 may receive one or more of the plurality of probability distributions themselves, or one or more data points that may be used to generate a probability distribution, via the network 106 (e.g., data that the transaction data engine 104 received, via the network 106, from the profile characteristic configuration manager 110), as data previously stored in, and retrieved from, the memory 116 of the transaction data engine 104, or from one or more probability distributions, or one or more data points defining them, that are stored in, and retrieved from, one or more databases of the transaction data engine 104, including, for example, from data stored in the probability distributions database 132.

The probability distribution generator 118 may cause the processor 114 to generate, a probability distribution, or range of possible values with their corresponding probabilities, for each of the different profile characteristics, which may be used (e.g., sampled) to generate transaction data for an entity. The probability distribution generator 118 may output a plurality of probability distributions that comprises at least one probability distribution for each of the different profile characteristics of the transaction data. For example, the probability distribution generator 118 may output, or may cause the processor 114 to generate, a plurality of probability distributions that comprises a probability distribution for at least each of the following parameters: a number of transactions occurring on each unit of time (e.g., the number of transactions per day); a transaction amount (e.g., a dollar value) for each transaction; a transaction category (e.g., a category of an item purchased on the transaction, such as groceries, leisure, travel, sporting event, food, vehicle, housing, etc.) of each transaction; a merchant (e.g., the entity with which the transaction took place) of each transaction; a location (e.g., within a specified radius of a predefined location) of each transaction (e.g., the place where a transaction occurs); and the like.

The probability distribution adjuster 120 may comprise programmable instructions that, upon execution, cause the processor 114 to adjust one or more probability distributions (e.g., generate a set of adjusted probability distributions) according to one or more profile characteristic configurations, which the probability distribution adjuster 120 may retrieve, for example, from the profile characteristic configuration database 130. As a result, the probability distribution adjuster 120 may output, or cause the processor 114 to output, a set of adjusted probability distributions. The probability distribution adjuster 120 may generate the set of adjust probability distributions by adjusting one or more aspects of an existing probability distribution (e.g., a probability distribution output previously by the probability distribution generator 118 or the probability distribution adjuster 120) according to the change(s) defined in the corresponding profile characteristic configuration. For example, the probability distribution adjuster 120 may generate one or more adjusted probability distributions by randomly perturbing each of the median value and the standard deviation, for an existing probability distribution, which may occur according to one or more profile characteristic configurations (e.g., stored in profile characteristic configuration database 130). As further examples, the profile characteristic configuration may define the types of changes that the probability distribution adjuster 120 may use to adjust a probability distribution that it received as an input. These changes, which the probability distribution adjuster 120 uses when it generates an adjusted probability distribution, may comprise one or more of the following: the number of different probability distributions to change, the parameter(s) of each probability distribution (e.g., a median value, a mean value, the standard deviation, the minimum possible value, the maximum possible value, and the like) to change (and by how much); whether the magnitude of a change is random, semi-random, or fixed; a set of data points for a change that fits each point in the set; whether a change includes randomly perturbing one or more parameters of a probability distribution; the nature and size of each perturbation to a parameter of a probability distribution; decreasing the probabilities for all values above a specified threshold; and the like.

In some embodiments, the probability distribution adjuster 120 may output, or cause the processor 114 to output, one or more adjusted probability distributions that are generated by adjusting an existing adjusted probability distribution, which was output by the probability distribution modifier 120. For example, the probability distribution adjuster 120 may adjust, or cause the processor 114 to adjust, one or more parameters of one or more adjusted probability distributions (e.g., a previous output). In doing so, the probability distribution adjuster 120 can generate one or more new adjusted probability distributions (e.g., a second set of adjusted probability distributions) according to the corresponding profile characteristic configuration(s). For example, after the probability distribution adjuster 120 outputs a first set of adjusted probability distributions, the probability distribution adjuster 120 can use the same first set of adjusted probability distributions as an input to generate a second set of adjusted probability distributions. The probability distribution adjuster 120 can do so by adjusting the adjusted probability distributions in the first set that was previously output by the probability distribution adjuster 120.

Alternatively, or in addition, in some embodiments the probability distribution adjuster 120 may generate multiple different sets of adjusted probability distributions at the same time or at nearly the same time, with each set of adjusted probability distributions comprising a probability distribution for each of the profile characteristics of the transaction data to be generated and stored in the transaction data database 128.

In some embodiments, the profile characteristics of the transaction data (e.g., the transactions stored in the transaction data database 128) may be comprised of a plurality of different attributes and the corresponding values that may be determined for every transaction individually (e.g., separately from the parameters of any other transaction(s)). For example, the profile characteristics of the one or more transactions may comprise at least a number of possible transactions per unit of time (e.g., a number of possible transactions per day), an individual transaction amount (e.g., a dollar value of each transaction), a cumulative transaction amount per unit of time (e.g., possible amounts for the total of all transactions to occur on a given day), a probability of one or more recurring transactions (e.g., a transaction that occurs at a specified frequency or on specified date(s) and with fixed values for each of the profile characteristics), and the like.

The machine learning model 122 may be, or include, any number of machine learning models of any type (e.g., a neural network, a support vector machine, random forest, etc.), which may receive transaction data (e.g., a dataset) for an entity and may generate, as output, one or more account prediction values for the transaction data provided for that entity. In some embodiments, the machine learning model is a dual-stage machine learning model that includes one or more sets of prediction layers. The one or more sets of prediction layers can be trained to generate one or more account prediction values that may each indicate a confidence score for, or a probability that, one or more events (e.g., each event corresponding to a single account prediction value) are associated with (e.g., reflected in) the transaction data provided as the input for the machine learning model 122. The one or more account prediction values include an account prediction value for one or more events, such as for example, an attrition event (e.g., amount per transaction, as an aggregate amount per day and/or individually, will decrease until reaching zero), a fraudulent transaction event (e.g., one or more transactions occurring in an unexpected region and/or abroad and the like), or an account status event (e.g., a change in a customer's primary bank or, otherwise, the primary account for an entity), etc.

The machine learning model 122 may generate an account prediction value by inserting or propagating the transaction data (e.g., the input for model 122) into a set of prediction layers (e.g., such as a neural network with a single or multiple layers (e.g., fully connected layers)) corresponding to a specific event (e.g., a marriage, a divorce, an attrition, etc.). For example, if the machine learning model 122 only includes one set of prediction layers, the machine learning model 122 may retrieve the set of prediction layers from memory 116 and insert the transaction data into the retrieved set of prediction layers. If the machine learning model 122 identifies the set of prediction layers based on an identification (e.g., an identification of an event) in a user input or a request, the machine learning model 122 may identify the set of prediction layers from memory based on the set of prediction layers corresponding to an identification in memory that matches the identification in the user input or the request (e.g., by using the identification of the set of prediction layers from the user input or request in a look-up technique in memory). The machine learning model 122 may retrieve the identified set of prediction layers from memory and insert the transaction data into the retrieved set of prediction layers. The machine learning model 122 may execute the set of prediction layers to generate the account prediction value for the transaction data provided as input to the machine learning model 122. Accordingly, the machine learning model 122 can predict values for different types of events based on the sets of prediction layers that the machine learning model 122 uses to make the prediction.

The processor 114 may train the machine learning model 122. The processor 114 can do so based on transaction data that includes labels that identify each of the profile characteristics, probability distributions, distribution modifiers, and/or events, if any, used to generate each transaction or that is otherwise associated with a transaction. More specifically, the machine learning model 122 may be trained based on the different profile characteristic configuration(s), distribution modifier(s), and/or event(s) and the transaction data that is associated with them, which the processor 114 identifies based on the labels that identify the transactions that are associated with the configurations or events. Stated differently, the machine learning model 122 may be trained from the labels, or identifiers, to determine which transaction values and parameters may be associated with each event of the one or more account prediction values (e.g., based on the probability distribution(s), profile characteristic configuration(s), and transaction parameters that may be prevalent among the transactions identified, by their labels, as associated with a given event(s)).

Additionally, the transaction data stored in the transaction database 128 may be used to train a machine learning model to identify one or more events that are associated with a set of transaction data based on the presence (or absence) of one or more patterns (e.g., one or more changes) in the different values of each parameter for each of the transactions of the transaction data. For example, the machine learning model 122 may be trained from one or more training datasets comprising transaction data that has been labelled with the profile characteristic configuration(s), distribution modifier(s), and/or events, if any, that are reflected in, or associated with, one or more transactions in the labelled transaction data. Additionally, the labelled transaction data may be used to train the machine learning model 122 to output an account prediction value in response to the transaction data provided to the model 122. The account prediction value may indicate a probability, or confidence score, that a particular event is associated with (e.g., is reflected in) at least a portion of the transaction data.

The probability distribution sampler 124 may sample each probability distribution in a set of probability distributions (e.g., a first set of adjusted probability distributions) to generate transaction data of one or more transactions and/or one or more sets of transactions. In some embodiments, the transaction data engine 104 may cause the distribution sampler 124 to generate transaction data of one or more transactions by an entity. The probability distribution sampler 124 and/or the transaction data engine 104 can generate transaction data by iteratively performing certain operations or operating according to one or more repeating loops. For example, the components 118-132 may perform certain operations, which may comprise a first repeating loop, for every unit of time (e.g., repeated for every day in the duration for the transaction data). Additionally, the components 118-132 may perform certain operations for every transaction on a given day, which may comprise a second repeating loop that is nested within the first repeating loop, as described in greater detail below.

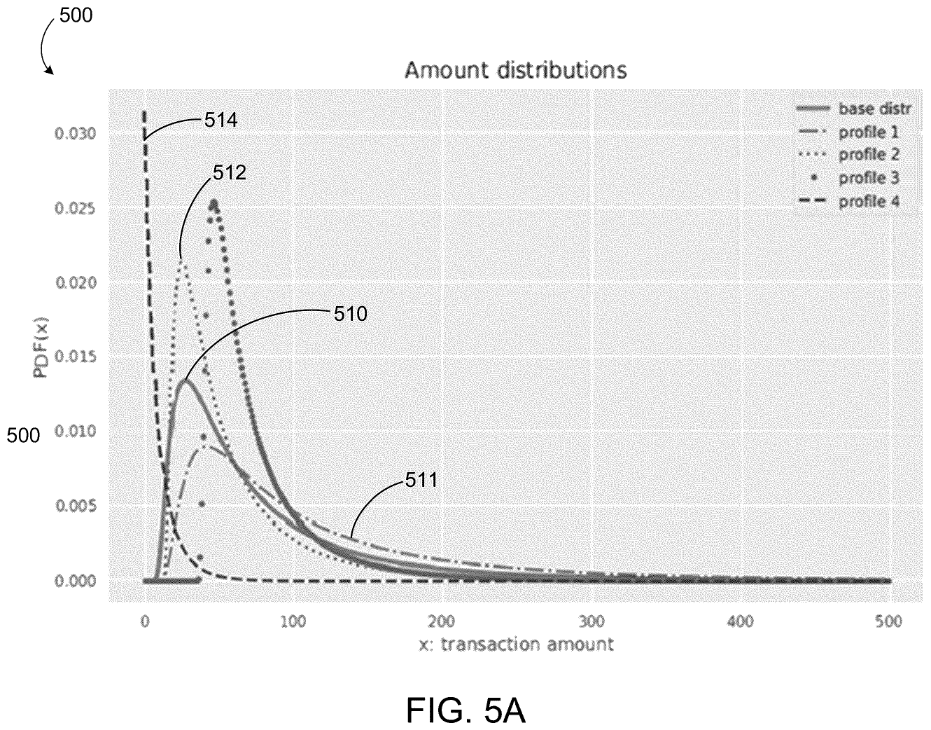

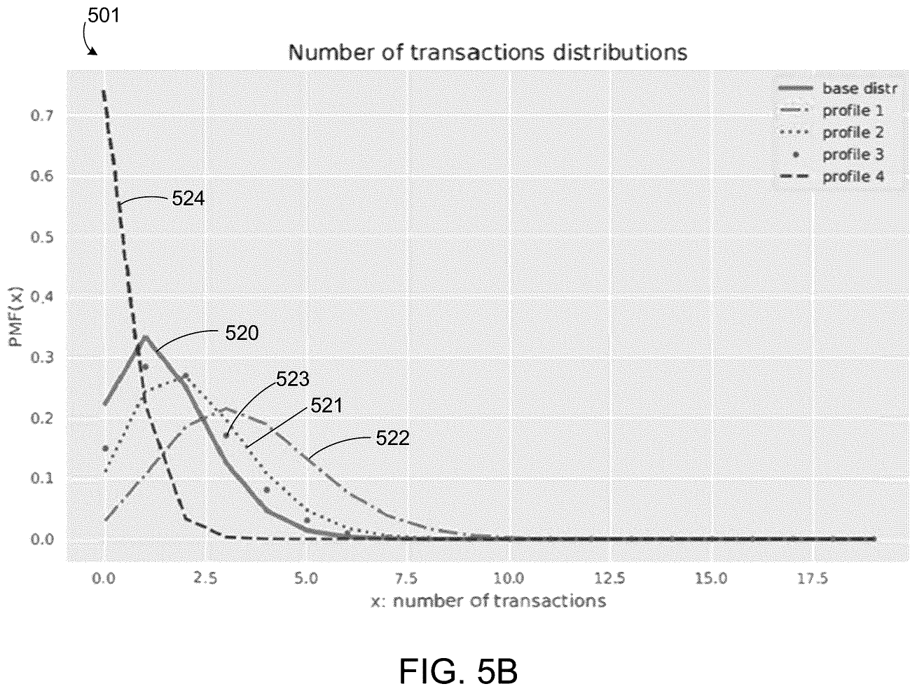

In some embodiments, the probability distribution sampler 124 may randomly sample the probability distribution for the number of possible transactions to occur per day, which may be an adjusted based on a profile characteristic configuration (e.g., a configuration retrieved from the profile characteristic configurations database 130 and/or received, via the network 106, from the profile characteristic configuration manager). For example, the probability distribution sampler 124 can randomly sample an adjusted probability distribution for the number of transactions per day (e.g., from a first set of adjusted probability distributions) and determine the number of different transactions on that day, for each of which transaction data should be generated. For example, in one embodiment, the probability distribution sampler 124 can determine a number of transactions to occur on each day in a given period of time by sampling one or more of the probability distributions in graph 500 illustrated in, and described with reference to, FIG. 5A.

In some embodiments, the probability distribution sampler 124 may maintain and increment a counter for the number of transactions determined to occur on a given unit of time (e.g., a given day) and for which transaction data has been generated. For example, for each transaction to occur on that day, the probability distribution sampler 124 samples one or more probability distributions (e.g., output by the probability distribution adjuster 120) to determine the characteristics for each transaction, which may include a probability distribution for the transaction amount (e.g., a dollar value), a probability distribution for the transaction category (e.g., a merchant category code associated with the transaction), and a probability distribution for the transaction location. After the probability distribution sampler 124 determines each of the characteristics for a transaction it then increases the counter, which represents the number of transactions for which transaction data has been determined. The probability distribution sampler 124 may then compare the value of the counter with the number of transactions occurring on that day to determine if there are any additional transactions on that same day and for which transaction data has not yet been generated (e.g., if the value of the counter is less than the number of transactions determined to occur on that day). Otherwise (e.g., if the value of the counter equals the number of transactions to occur on that day), the probability distribution sampler 124 may determine the transaction data need not be generated for any additional transactions.

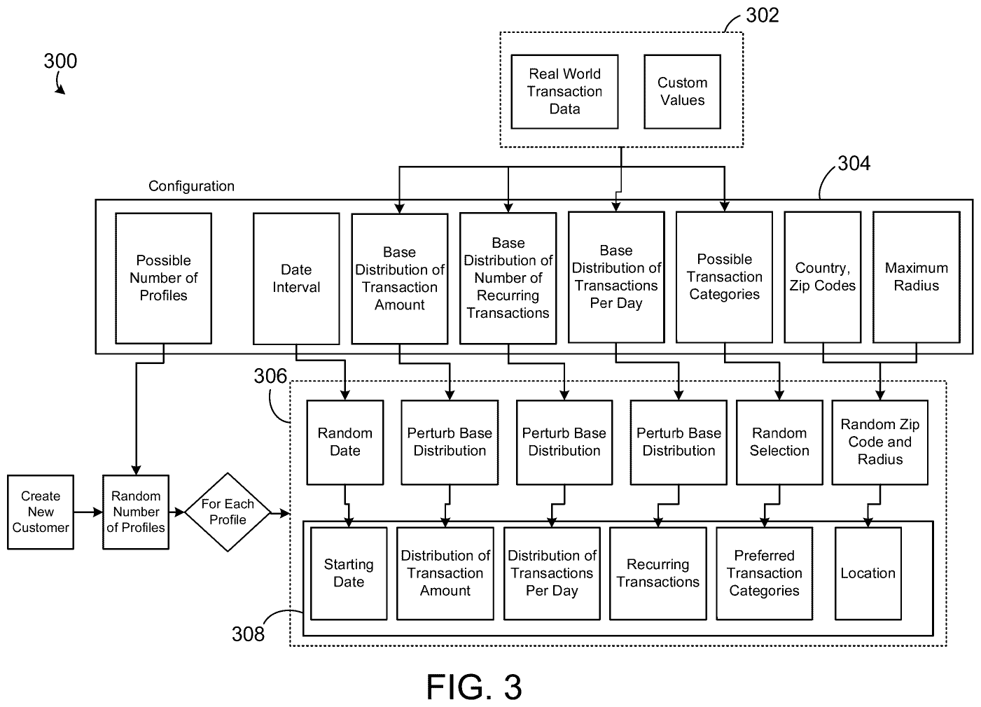

The transmitter 126 may comprise programmable instructions that, upon execution, cause the processor 114 to apply transmit and/or receive messages with computers such as the client device 102, the data source 108, or the profile characteristic configuration manager 110. The transmitter 126 may be or include an application programming interface (API) that enables communication across the network 106. The transmitter 126 may transmit the transaction data of one or more transactions to the client device 102 and/or the profile characteristic configuration manager 110. In doing so, the transmitter 126 may transmit the transaction data to a remote computing device that is accessed by an administrator that may view the transaction data on a user interface. The administrator may view the transaction data of one or more transactions, configuration data used to generate the transaction data (e.g., set of initial parameters 304 described with reference to FIG. 3), and/or one or more profile characteristic configurations corresponding to the transaction data transmitted to the profile characteristic configuration manager 110 via the transmitter 126.

The profile characteristic configurations database 130 may comprise one or more databases (e.g., databases in a distributed system) containing one or more profile characteristic configurations received by the transaction data engine 104 to generate a set of adjusted probability distributions. The profile characteristic configurations database 130 may store sets of profile characteristic configurations for different individual entities (e.g., individual customers and/or accounts) and/or group entities (e.g., companies, households, organizations, etc.). Each profile characteristic configuration comprises information for determining a corresponding characteristic of the transaction data associated with (generated by) that profile characteristic. For example, a profile characteristic configuration may comprise an adjusted probability distribution for one characteristic (e.g., number of transactions per day) and one or more identifiers for information (e.g., any distribution modifier(s) or event(s), types of customers or accounts, etc.) associated with it. Further, each profile characteristic configuration may comprise a time (e.g., a start date and an end date) during which that configuration constitutes the active profile characteristic configuration (e.g., the configuration used to determine that characteristic when generating transaction data). Additionally, the profile characteristic configurations may be used and stored in a set of profile characteristic configurations, which comprises a single configuration for each of the different characteristics of the transaction data (e.g., transactions per day, transaction amount, recurring transactions, transaction category or merchant category code, and transaction location). The sets of profile characteristic configurations may be stored as data structures with one or more attribute-value pairs, as described herein. The different sets of profile characteristic configurations may be stored in profile characteristic configurations database 130 and may be updated over time as the transaction data engine 104 either receives new values for the and/or for attribute-value pairs for the accounts.

In some embodiments, the profile characteristic configuration database 130 may be comprised of the profile characteristics used to adjust one or more probability distributions for each of the different profile characteristics for, or parameters of, the transaction data. For example, the profile characteristic configuration database 130 may contain the profile characteristic configurations that the probability distribution adjuster 120 may use to adjust a probability distributions for one or more of the following profile characteristics: the number of transactions that may occur on a given unit of time (e.g., a number of transactions per day), a transaction amount (e.g., a dollar value) for each transaction, the probability that one or more recurrent transactions occurs, the possible merchant category codes (e.g., a category of an item purchased on the transaction, such as groceries, leisure, travel, sporting event, food, vehicle, housing, etc.) of each transaction, or a location (e.g., a location where the transaction occurs) for each transaction. In some embodiments, each of the probability distributions may be a normal distribution with a given median, mean, and standard deviation (e.g., the probability distributions illustrated in FIGS. 5A and 5B).

The probability distribution database 132 may comprise one or more databases (e.g., databases in a distributed system). The probability distribution database 132 may store one or more sets of probability distributions, which may include one or more adjusted probability distributions and/or one or more unadjusted probability distributions, for generating transaction data for different individual entities (e.g., individual people) and/or group entities (e.g., companies, households, organizations, etc.). Each of the probability distributions stored in the probability distribution database 132 may define a range of possible values for a profile characteristic of the transaction data generated by the transaction data engine 104 and the corresponding probabilities for each of the possible values. Stated differently, the probability distributions may include a variety of different profile characteristics, which are attribute-value pairs reflecting a different attribute of a transaction and the different probability distributions for the possible values for that attribute. For example, the profile characteristics may include a probability distribution for each of the following attribute-value pairs, which can be sampled to generate the transaction data associated with that attribute of a transaction: a number of transactions to occur that day, a value (e.g., amount) of each transaction, a category (e.g., a category of an item purchased on the transaction, such as groceries, leisure, travel, sporting event, food, vehicle, housing, etc.) of each transaction, a merchant (e.g., the entity with which the transaction took place) of each transaction, a location (e.g., within a specified radius of a predefined location) associated with each transaction, and the like. Alternatively or in addition the data processing system can receive one or more of the probability distributions via a network (e.g., network 106), from data stored in memory (e.g., memory 116), and/or from the probability distribution database 132.

FIG. 2A is an illustration of a method for generating transaction data for one or more transactions to train a machine learning model based on the same in accordance with an implementation. The method 200 can be performed by a data processing system (a client device or a transaction data engine 104, shown and described with reference to FIG. 1, a server system, etc.). The method 200 may include more or fewer operations and the operations may be performed in any order. Performance of the method 200 may enable the data processing system to generate synthetic transaction data for one or more transactions performed over time and to use a machine learning architecture to identify events, such as attrition of account(s), associated with the transactions.

At operation 202, the data processing system generates a plurality of probability distributions for generation of transaction data for one or more entities. Each of the probability distributions can correspond to a parameter of the transaction data to be generated and they may each define a range of the possible values for the corresponding parameter (e.g., feature) of the one or more transactions of the transaction data. Stated differently, each probability distribution of the plurality of probability distributions may correspond to different profile characteristics, or attribute-value pairs, which may define the range of possible values for determining that profile characteristic of one or more transactions of the transaction data. Moreover, the plurality of probability distributions generated at operation 202 may define a function for the range of possible values for that profile characteristic and their corresponding probabilities, which may be used to determine the outcome of a random, or semi-random, sampling. For example, the profile characteristics may include a probability distribution for each of the following attribute-value pairs, or parameters, which may each define a probability distribution to randomly sample, or otherwise generate, the transaction data associated with that attribute of a transaction: a number of transactions to occur that day; a transaction amount (e.g., a dollar value) of each transaction; a transaction category (e.g., a category of an item purchased on the transaction, such as groceries, leisure, travel, sporting event, food, vehicle, housing, etc.) of each transaction, a merchant (e.g., the entity with which the transaction took place) of each transaction; a location (e.g., within a specified radius of a predefined location) associated with each transaction (e.g., a location at which a transaction occurs); and the like. Alternatively, or in addition, the data processing system can receive one or more of the probability distributions via a network (e.g., network 106) or from memory (e.g., memory 116).

At operation 204, the data processing system retrieves a first profile characteristic configuration for each of the probability distributions and a start time (e.g., a timestamp and/or date) associated with the first profile characteristic configurations. In retrieving the first profile characteristic configuration for each of the probability distributions, the data processing system may retrieve values for the particular probability distribution associated with that profile characteristic, such as a median value, a mean value, a standard deviation, minimum and maximum values, and the like. The data processing system may retrieve the first configurations for one profile characteristic by retrieving a median, a mean, and a standard deviation for the probability distribution associated with that profile characteristic. For example, the data processing system may retrieve a first profile characteristic configuration for the number of possible transactions to occur within a defined period of time. The data processing system may retrieve the configurations of the profile characteristics from memory or a database by identifying configurations associated with an active profile for a defined period of time and retrieving the values that correspond to the profile characteristics of the identified configurations. For example, the data processing system may identify the presently active profile based on the time period for which transaction data will be generated. The data processing system may retrieve the configurations for each profile characteristic by retrieving one or more values corresponding to each probability distribution (e.g., a mean value, median value, and a standard deviation value). Alternatively, or in addition, the data processing system may receive one or more of the configurations for the profile characteristics as inputs from a user and/or via a network (e.g., as configuration data received over the network 106 shown in, and described with reference to, FIG. 1).

At operation 206, the data processing system adjusts each of the probability distributions according to the retrieved first profile characteristic configurations to generate a first set of adjusted probability distributions. The data processing system can adjust a probability distribution of possible transaction amounts according to the configuration for that profile characteristic that it received in operation 204. For example, the data processing system may adjust an existing probability distribution by randomly perturbing one or more characteristics of that probability distribution, including the median value, the minimum value, the maximum value, and the standard deviation (where the probability distribution is a normal distribution).

Alternatively, or in addition, the data processing system may adjust one or more existing probability distributions by changing one or more of their characteristics by a predetermined amount, which may be an amount that is included in (e.g., defined by) a profile characteristic configuration for that probability distribution. For example, the data processing system may randomly perturb an existing probability distribution (e.g., a previously adjusted probability distribution) by decreasing the median and maximum values by half and by doubling the standard deviation of that same existing probability distribution.

The data processing system can similarly adjust each of the probability distributions associated with the transaction data to be generated (e.g., for each of the profile characteristics in the set of profile characteristic configurations 308 shown in and described with reference to FIG. 3). In some embodiments, the data processing system can adjust a probability distribution corresponding to each profile characteristic used to generate the one or more transactions. For example, the data processing system may adjust a probability distribution for each of the number of transactions that may occur per day, the amount per transaction, the probability of a recurrent transaction, the possible merchant category codes (e.g., a category of an item purchased on the transaction, such as groceries, leisure, travel, sporting event, food, vehicle, housing, etc.) for each transaction, and a location (e.g., a location within a certain radius of a specified location) for each transaction. In some embodiments, each of the probability distributions may be a normal distribution with a given median, mean, and standard deviation (e.g., the probability distributions illustrated in FIGS. 5A and 5B).

At operation 208, the data processing system samples each of the first set of adjusted probability distributions to generate transaction data for one or more first transactions. In some embodiments, the data processing system first samples the probability distribution for the number of possible transactions, which has been adjusted based on the profile characteristic configuration (e.g., as retrieved at operation 204). For example, for each day (or other time period) for which transaction data will be generated, the data processing system can randomly sample an adjusted probability distribution for the number of possible transactions per day to determine the number of transactions on that day and for each of which transaction data must be generated. In some embodiments, the data processor maintains and increments a counter for the number of transactions on a given unit of time (e.g., a given day) and for which transaction data has been generated. For each transaction on that day, the data processing system samples a set of probability distributions (e.g., one or more adjusted probability distributions) to determine the characteristics for that transaction, which may include sampling a probability distribution for the transaction amount (e.g., a dollar value), sampling a probability distribution for the transaction category (e.g., a merchant category code associated with the transaction), and sampling a probability distribution for the transaction location (e.g., a radius from a specified location). After the data processing system determines each of the characteristics for a transaction it then increases the count of the counter, which represents the number of transactions for which transaction data has been determined. The data processing system then compares the count of the counter with the number of transactions occurring on that day to determine if there are any additional transactions on that same day and for which transaction data has not yet been generated (e.g., if the count of the counter is less than the number of transactions occurring on that day). Otherwise (e.g., if the value of the counter equals the number of transactions occurring on that day), the data processing system determines that transaction data need not be generated for any additional transactions on that day and it may then determine whether one or more transactions occur on the next day for which transaction data should be generated or it may determine that it has generating the transaction data for every day in the specified period of time (e.g., the period of time during which one or more transactions may occur and specified by a start date and an end date).

At operation 210, the data processing system determines whether to generate transaction data using multiple profile characteristic configurations. The data processing system may determine whether to generate transaction data using multiple profile characteristic configurations by identifying the period of time for which transaction data is to be generated. Alternatively, or in addition, the data processing system may determine whether to generate transaction data using multiple profile characteristic configurations by randomly sampling a probability distribution for the number of possible profile characteristic configurations for which transaction data is to be generated for a specified period of time.

In some embodiments, the data processing system may determine whether any profile characteristic configurations have been retrieved (e.g., as described at operation 204) for which no transaction data has been generated. For example, the data processing system can determine that second and third profile characteristic configurations have been received for the data processing system to use in generating a customer's transaction data, reflecting the customer's spending behavior as it changes over time (e.g., for a plurality of transactions associated with the customer and occurring over a specified period of time).

Responsive to determining to generate transaction data using multiple profile characteristic configurations, at operation 212, the data processing system retrieves one or more additional profile characteristic configurations for each of the probability distributions and one or more additional start times (e.g., one or more specified dates) associated with the one or more additional profile characteristic configurations. In retrieving the additional profile characteristic configurations for each of the probability distributions, the data processing system may retrieve additional values for the particular probability distribution associated with that profile characteristic, such as a median value, a mean value, a standard deviation, minimum and maximum values, and the like, which together define a probability distribution of possible values, for example, as a normal (Gaussian) distribution of the values for the associated probability distribution (e.g., as shown in FIGS. 5A and 5B). Alternatively, or in addition, the data processing system may retrieve a custom function (e.g., range of values and associated probabilities) for one or more of the additional profile characteristic configurations.

In some embodiments, the data processing system may retrieve the additional profile characteristic configuration(s) by retrieving a set of parameters comprised of, at least, a median value, a mean value, and a standard deviation for the probability distribution associated with that same profile characteristic. For example, the data processing system may retrieve an additional profile characteristic configuration of the profile characteristic for the number of transactions that may occur on a given unit of time (e.g., number of possible transactions per day) by retrieving a set of additional parameters comprising, at least, of: a median number of transactions per day, a maximum number of transactions per day, and a standard deviation for adjusting that probability distribution, each of which may differ from the equivalent parameters that were retrieved by the data processing system at operation 204.

In some embodiments, the data processing system may retrieve the sets of one or more additional configurations of the profile characteristics from memory or a database by identifying configurations associated with one or more additional profile(s) associated with the defined period of time for which transaction data will be generated and retrieving the values that correspond to the profile characteristics of the identified configurations. For example, the data processing system may identify the set of one or more additional profile configurations based on the latest time period for which transaction data has already been generated. The data processing system may retrieve the configurations for each profile characteristic by retrieving the associated values (e.g., mean, median, and standard deviation) for each of the probability distributions.

At operation 214, the data processing system adjusts each of the probability distributions according to the retrieved first profile characteristic configurations to generate a first set of adjusted probability distributions. For example, the data processing system can adjust an existing probability distribution of possible transaction amounts according to the configuration for that profile characteristic that it received in operation 204. The data processing system can do so by randomly, semi-randomly, or based on an input from a user interface, perturbing one or more characteristics of that probability distribution (e.g., changing one or more of a minimum value, a maximum value, the median value, the mean value, or the standard deviation). The data processing system can similarly adjust each of the probability distributions associated with the transaction data to be generated (e.g., for each of the profile characteristics in the set of profile characteristic configurations 308 shown in, and described with reference to, FIG. 3). In some embodiments, the data processing system can adjust a probability distribution for each of the value associated with each transaction, the number of transactions to occur per day, the probability of a recurrent transaction occurring, the possible merchant category codes (e.g., a category of one or more items purchased by, or associated with, the transaction, such as groceries, leisure, travel, sporting event, food, vehicle, housing, etc.) for each transaction, and a possible location (e.g., a location within a certain radius of a specified location) for each transaction. Each of the probability distributions can be associated with a particular median, mean, and standard deviation of a probability distribution (e.g., as shown in FIGS. 5A and 5B).

At operation 216, the data processing system samples an additional set of adjusted probability distributions, which are each based on corresponding additional profile characteristic configurations, to generate transaction data for one or more additional transactions. In some embodiments, the data processing system may first sample an adjusted probability distribution to determine a number of possible transactions, which probability distribution has been adjusted based on an additional profile characteristic configuration (e.g., retrieved at operation 212 and adjusted at operation 214), for a unit of time (e.g., occurring on a given day for which the additional profile characteristic configurations qualify as the ‘active’ profile characteristic configuration). For example, to generate transaction data on the additional start time received at operation 214, the data processing system can randomly sample the adjusted probability distribution corresponding to the number of possible transactions that may occur on that day and output the number of transactions based on the randomly sampled probability distribution to generate transaction data for each such transaction.

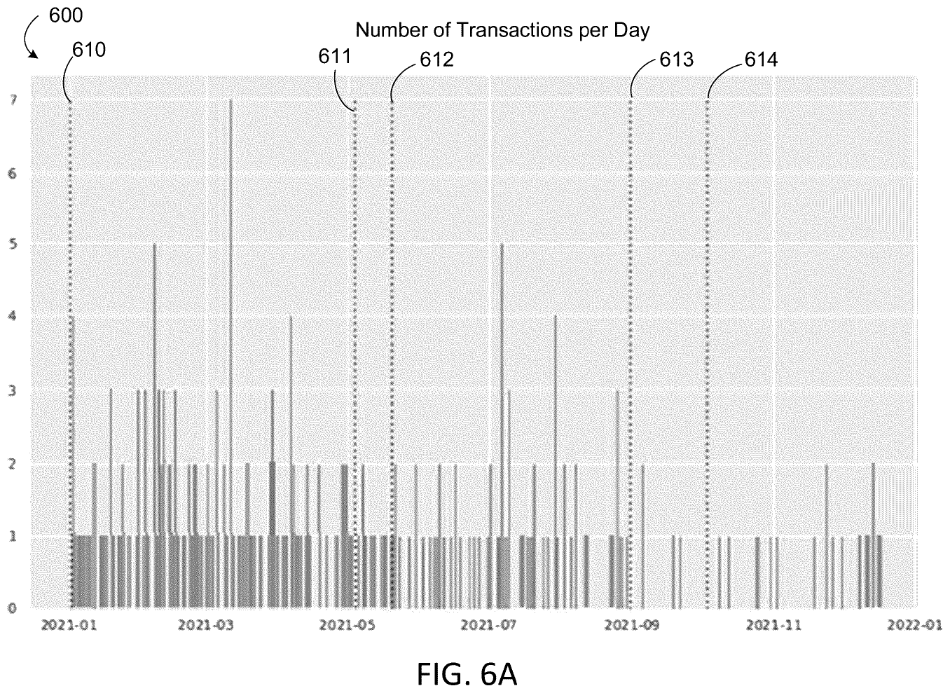

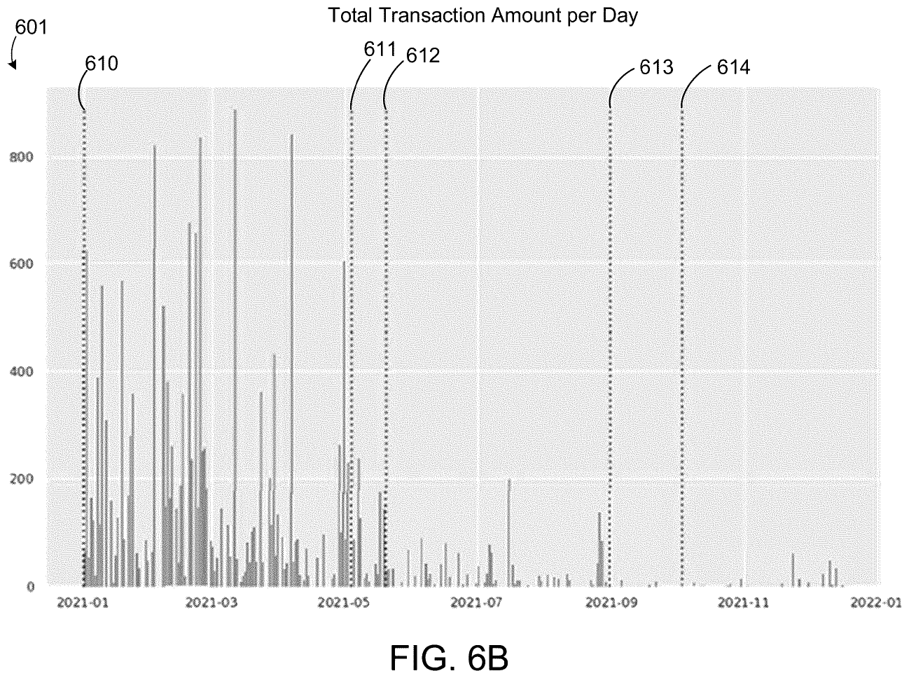

For example, in one embodiment, the data processing system can generate transaction data for every day over which transaction data should be generated. On each day the data processing system determines a number of transactions to occur on that day (e.g., the values depicted in the graph 600 shown in, and described with reference to, FIG. 6A, illustrating the number of transactions occurring per day for transaction data generated over a period of time). Then, for each of the transactions determined to occur on that day, the data processing system can determine the characteristics of that transaction (e.g., the transaction amount or dollar value, the transaction category or merchant code, and the location) by randomly sampling the corresponding probability distribution (e.g., the probability distribution corresponding to an active profile characteristic configuration). The data processing system may then determine whether transaction data has been generated for the end date or whether transaction data should be generated for the next day. In response to determining that transaction data should be generated for the next day, the data processing system determines whether the next day is the start date for a new profile characteristic configuration (e.g., whether to change the active profile characteristic configuration before generating transaction data for the following day).

At operation 218, the data processing system can determine whether it will generate transaction data for one or more transactions based on one or more additional profile characteristic configurations (e.g., whether it will repeat the functionalities described for operations 212-216 based on one or more additional profile characteristic configurations). For example, in some embodiments the data processing system may receive five different profile characteristic configurations for each of the probability distributions and generate transaction data for one or more transactions based on each of the different profile characteristic configurations (e.g., by repeating the functionalities described for operations 212-216 for each of the different profile characteristic configurations). For example, the data processing system may, in one embodiment, generate transaction data for one or more transactions by sampling each of the different probability distributions illustrated in FIGS. 5A and 5B, which may each be based on a different profile characteristic configuration received by the data processing system.

In some embodiments, the data processing system may maintain and increment a counter for every additional profile characteristic configuration that the data processing system receives, identifies, and/or generates and which it may use to generate transaction data based on the same. In such embodiments, the data processing system may determine there are one or more additional profile characteristic configurations (with which transaction data should be generated) if the count of the counter exceeds one. Otherwise, the data processing system may determine that there are no additional profile characteristic configurations for which transaction data should be generated. Instead, the data processing system may, in some embodiments, determine that a machine learning model will be trained without generating any additional transaction data (e.g., without repeating any of the functionalities described with reference to operations 212-216).

At operation 220, the data processing system trains a machine learning model to generate an account prediction value using the transaction data. In some embodiments the data processing system may train a machine learning model using transaction data generated for the one or more transactions associated with one or more different adjusted probability distributions (e.g., one or more sets of probability distributions, which were each adjusted based on different profile characteristic configurations). The data processing system can generate a training data set from the transaction data. The data processing system can label the training data set with a ground truth value for an account prediction value (e.g., a profile characteristic configuration that corresponds to an account prediction value), in some cases as selected or generated by the data processing system. The data processing system can feed the training data set into the machine learning model to generate an output. The data processing system can determine a difference between the output and the labels according to a loss function. The data processing system can use back-propagation techniques to adjust the weights and parameters of the machine learning model according to the difference. The data processing system can continuously generate sets of training data and train the machine learning model using the sets of training data over time to generate accurate predictions of account prediction values.

The data processing system can train different machine learning models or different sets of prediction layers. Each machine learning model or set of prediction layers can correspond to a different account prediction value. For example, each set of adjusted probability distributions can correspond to a different account prediction value or type of account prediction value (e.g., have a stored association with an identifier of a type of account prediction value). The data processing system can generate transaction data for transactions from a set of adjusted probability distributions. The data processing system can generate a training data set from the generated transaction data by creating a feature vector from the generated transaction data and labeling the feature vector with an indicator or the identifier of the type of account prediction value (e.g., a ground truth value). In one example, the indicator can indicate that the training data set indicates an individual experiencing attrition, a marriage, or a divorce. The data processing system can train (e.g., using a loss function and back-propagation techniques) a machine learning model or set of prediction layers that corresponds to the same type of account prediction value (e.g., has a stored association with an identifier of the type of account prediction value). The data processing system can similarly train any number of machine learning models or sets of prediction layers. Training sets of prediction layers is described in U.S. patent application Ser. No. 17/898,898, filed Aug. 30, 2022, the entirety of which is incorporated by reference herein.

FIG. 2B is an illustration of a method 230 for generating transaction data for one or more transactions to train a machine learning model based on the same in accordance with an implementation. The method 230 can be performed by a data processing system (a client device 102 or a transaction data engine 104, shown and described with reference to FIG. 1, a server system, etc.). The method 230 may include more or fewer operations and the operations may be performed in any order. One or more of the operations of the method 230 may be performed during, or in lieu of, operation 214, shown in, and described above with reference to, FIG. 2A. Performance of the method 230 may enable the data processing system to generate transaction data for one or more transactions, including one or more events injected into the transaction data (e.g., using a distribution modifier) to cause the transaction data to change over time. Additionally, performance of the method 230 may cause the data processing system to generate a training dataset comprising the transaction data for the one or more transactions and one or more labels to identify one or more corresponding distribution modifier(s) (e.g., one or more distribution modifiers of one or more events injected into the transaction data), which the data processing system may use to train a machine learning architecture using the same (e.g., a machine learning model capable of identifying whether transaction data includes any of the one or more events).

At operation 232, the data processing system receives one or more distribution modifiers for one or more of the profile characteristic configurations. In some embodiments the distribution modifiers may indicate a change to one or more profile characteristic configuration(s) and/or one or more probability distribution(s). Each distribution modifier may have a stored association with a different type of event (e.g., a marriage, divorce, move, job change, etc.) in memory. In one example, the received one or more distribution modifiers may cause the total number of transactions to decrease with each subsequent set of profile characteristic configurations until it reaches zero. In another example, the one or more distribution modifiers may cause the transaction amount, either individually or in the aggregate, to decrease with each unit of time or with every subsequent start time for a set of profile characteristic configurations, which may specify that the transaction amount reaches zero before the end of the period of time for which the data processing system will generate transaction data of one or more transactions by that entity (e.g., before the final date of the transaction data).

At operation 234, the data processing system adjusts one or more set(s) of probability distributions according to the corresponding profile characteristic configuration and the received one or more distribution modifier(s) to generate a second set of adjusted probability distributions. In some embodiments the data processing system generates one or more sets of probability distributions (e.g., adjusted or unadjusted probability distributions such as a second set, a third set, fourth set, of adjusted probability distributions etc.) based on the received one or more distribution modifiers, the corresponding profile characteristic configuration(s), and/or the (unadjusted) probability distributions.

At operation 236, the data processing system samples each of the second set of adjusted probability distributions, which have been adjusted according to one or more received distribution modifier(s), to generate transaction data for one or more transactions. For example, the data processing system may sample each of the second set of adjusted probability distributions by randomly determining a value for each profile characteristic based on the values and their respective probabilities described by each distribution of the second set of adjusted probability distributions.

At operation 238, the data processing system determines whether it should generate additional transaction data for one or more transactions. For example, the data processing system may determine that additional transaction data should be generated based on a comparison of the most recent transaction that has been generated and the period of time for which the data processing system should generate transaction data (e.g., based on a comparison with the interval of time of the configuration data described above). Alternatively, or in addition, the data processing system may determine if additional transaction data should be generated based on the latest start time of a profile characteristic configuration received by the data processing system.

At operation 240, in response to determining not to generate additional transaction data at operation 238, the data processing system identifies transaction data of one or more transactions and one or more distribution modifiers corresponding to the identified one or more transactions. For example, the data processing system may identify transaction data of one or more transactions occurring after a specific date and a distribution modifier associated with that transaction data (e.g., a distribution modifier used in generating the identified transaction data). Alternatively, or in addition, the data processing system may label a portion of the transaction data of one or more transactions with an identifier for a corresponding distribution modifier for the identified transaction data.

At operation 242, the data processing system generates a record (e.g., a file, document, table, listing, message, notification, etc.) comprising the identified transaction data and the corresponding one or more received distribution modifier(s) used in generating the identified transaction data. For example the data processing system may generate an index mapping the transaction data of one or more transactions onto one or more distribution modifiers used to generate it. Alternatively, or in addition, the data processing system may generate a record that comprises a labeled copy of the transaction data of one or more transactions, which may be labeled to identify, or according to, one or more distribution modifiers, and/or one or more sets of profile characteristic configurations, used in generating the transaction data of the one or more labeled transactions.

Alternatively, or in addition, in some embodiments, the data processing system may generate a record based on the transaction data generated for one or more transactions and the associated set of profile characteristic configurations used to generate the one or more set(s) of adjusted probability distributions. The data processing system may generate the record by including any account prediction values the machine learning model output and/or the distribution modifier(s) used by the data processing system, if any, to generate the transaction data.

FIG. 3 is an illustration of a sequence 300 for generating a set of probability distributions and generating one or more profile characteristic configurations for use in generating transaction data for one or more transactions. The sequence 300 may include operations that are performed by a data processing system (e.g., the client device 102 or the transaction data engine 104, shown and described with reference to FIG. 1, a server system, etc.). The sequence 300 may include more or fewer operations and the operations may be performed in any order.

In the sequence 300, the data processing system may receive and/or comprise a database 302 that contains real world transaction data and/or one or more custom values, which may be used to configure a set of probability distributions (e.g., as part of operation 202 illustrated in and described with reference to FIG. 2A). For example, in some embodiments the data processing system may use the information stored in database 302 (e.g., real-world transaction data and/or one or more custom values) to configure a set of initial parameters 304, which comprise at least a set of unadjusted probability distributions or base distributions, which may be used to generate one or more adjusted probability distributions (e.g., as shown in and described with reference to operation 206 of FIG. 2A). In some embodiments, the database 302 may store one or more custom values that have been provided as input to, or otherwise received by, the data processing system.

In sequence 300, the data processing system may receive, and/or generate the set of initial parameters 304, which comprise a base distribution for one or more of the following parameters or profile characteristics: a number of the different sets of profile characteristic configurations with which the data processing system may generate the transaction data for an entity, the time period (e.g., a date range or number of days) for which the data processing system may generate the transaction data for the entity, a probability distribution for the possible amounts (e.g., values) that may be associated with each transaction (e.g., value per transaction), a probability distribution for the possibility of transaction recurring (e.g., the probability of a transaction having a predetermined amount, occurring with a specified frequency, and having a predetermined location and category, etc.), a probability distribution for the possible number of transactions that may occur on each unit of time (e.g., possible number of transactions per day), a probability distribution for a category associated with each transaction, one or more possible counties and/or zip codes and a maximum distance (e.g., radius) from those same counties and/or zip codes.

In the sequence 300, the data processing system may determine how many different sets of profile characteristic configurations, such as the set of profile characteristic configurations 308 in sequence 300, to use in generating the transaction data for a particular entity. In some embodiments, the data processing system may randomly determine the number of different sets of profile characteristic configurations to use as a randomly determined value above a specified minimum (e.g., 1, 2, 5, etc.) but below a specified maximum (e.g., 3, 5, 10, 100, etc.). For example, the data processing system may randomly determine, based on the information stored in database 302 (e.g., based on real-world transaction data and/or one or more custom values), to generate several different sets of profile characteristic configurations for generating transaction data of one or more transactions by an entity.

After the data processing system has determined how many sets of different profile characteristic configurations it may generate each of the different sets equal to the determined number. For example, at operation 306 of sequence 300, the data processing system may configure a set of profile characteristic configurations with a profile characteristic configuration for each initial parameter in the set of initial parameters 304. In some embodiments, in the sequence 300 the data processing system may determine a set of profile characteristic configurations 308 by randomly (e.g., pseudo-randomly) perturbing one or more of the parameters in the set of initial parameters 304.

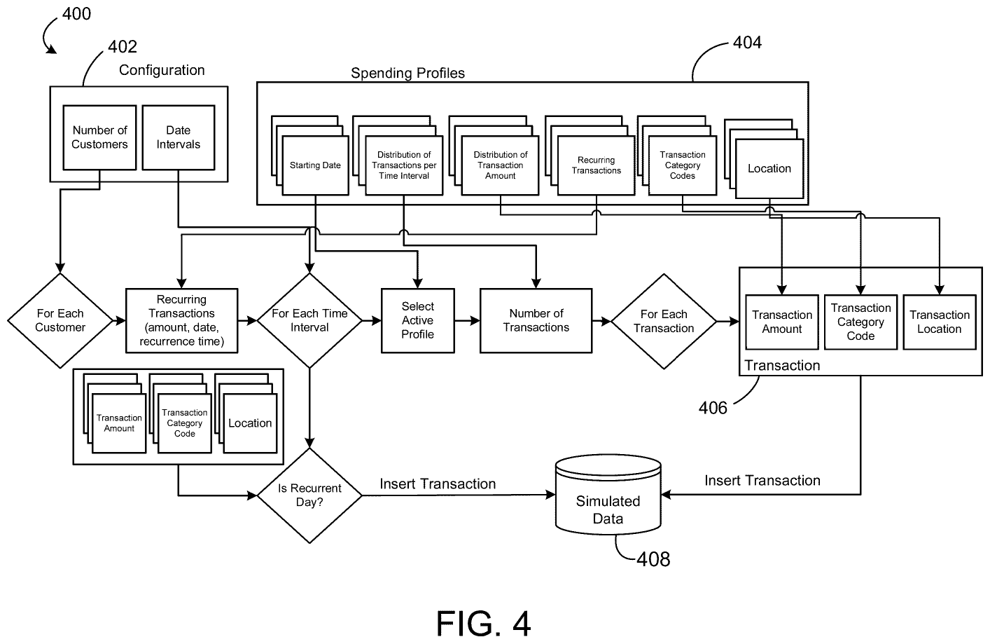

FIG. 4 is an illustration of a sequence 400 for generating, for one or more entities, (e.g., simulated customers), transaction data 408 for one or more transactions 406 of one or more different profile characteristic configurations 404. The sequence 400 may include operations that are performed by a data processing system (e.g., the client device 102 or the transaction data engine 104, shown and described with reference to FIG. 1, a server system, etc.). The sequence 400 may include more or fewer operations and the operations may be performed in any order.

In the sequence 400, the data processing system may determine a configuration 402 that it may use in generating the transaction data 408. In some embodiments, the configuration 402 may comprise both the number of entities (e.g., a number of customers and/or accounts) and the period of time (e.g., the number of calendar days) for which the data processing system will generate transaction data 408. For example, in some embodiments, in sequence 400 the data processing system may determine a configuration that comprises a single entity and a period of thirty calendar days (e.g., to generate transaction data for the single entity over thirty days).

In sequence 400, the data processing system may include one or more different sets of profile characteristic configurations 404 (e.g., one or more different sets of profile characteristic configurations described with reference to the profile characteristic configurations database 130 shown in, and described with reference to, FIG. 1). For example, in sequence 400 the data processing system may have previously received and/or generated one or more of the different sets of profile characteristic configurations 404 (e.g., as described with reference to operations 204 and 212 shown in FIG. 2A).

In sequence 400, the data processing system may generate transaction data for one or more transactions by an entity using each of the different sets of profile characteristic configurations 404, which may be used by the data processing system in order of the start time associated with each of the different sets of profile characteristic configurations. The one or more profile characteristic configurations may each correspond to different, sequentially occurring, portions of the time period specified by the configuration 402. For example, in some embodiments the different profile characteristic configurations are each associated with a different start time occurring sequentially within the period of time specified by the configuration 402 for the transaction data to be generated. In some embodiments, the data processing system may determine the start time associated with each of the profile characteristic configurations 404. Alternatively, or in addition, the data processing system may receive one or more start times of the one or more profile characteristic configurations 404 (e.g., via the network 106 shown in, and described with reference to, FIG. 1).

The data processing system may generate the transaction data 408 for one or more transactions of each unit of time (e.g., each day) within the period of time specified by the configuration 402 according to the profile characteristic configurations and their associated start times. More specifically, the data processing system may first generate transaction data based on the profile characteristic configuration with the first start time and continue to do for each day in the period of time specified by the configuration 402 until it determines the date for which it will next generate transaction data is equal to the start time of a second profile characteristic configuration. In response to that determination, the data processing system may generate a second set of adjusted probability distributions based on the second profile characteristic configuration and sample the second set of adjusted probability distributions to generate transaction data 408 for each day in the period of time of the configuration 402 until the date equals the start time of a third profile characteristic configuration or until the last day in the period of time that is specified by the configuration 402.

In one example, the data processing system may sample each of the adjusted probability distributions, in a second set of adjusted probability distributions, to generate transaction data for one or more second transactions that occur with a frequency (e.g., a number of transactions per day) that decreases to zero by at least a specified date (e.g., an attrition date) or within a specified period of time (e.g., during a period of time that begins while the data processing system is using the first active profile characteristic configuration to generate the transaction data and that ends after the data processing system has begun using at least a second active profile characteristic configuration (e.g., after at least one change in the active profile characteristic configuration)). For example, the data processing system may generate the transaction data 408 for each unit of time (e.g., each day) that includes zero transactions per day (e.g., transactions occurring with a frequency that reaches zero) at least by a specified date (e.g., an attrition date), or within a period of time specified by an attrition event (e.g., after a start time for at least a second profile characteristic configuration or after at least one change in the active profile characteristic configuration). The data processing system can use the generated transaction data 408 as a training data set to train a machine learning model to detect attrition (e.g., a train a machine learning model associated with an identifier of the profile characteristic configuration that corresponds to attrition). Capturing training data generated using training data generated under both profile characteristics can better train the machine learning model to identify changes in transaction data that indicate attrition.

In some embodiments, in the sequence 400 the data processing system may generate transaction data for one or more recurring transactions with a predetermined amount, location, and category, which occur according to a specified frequency or on a specified day of the month. For example, in the sequence 400 the data processing system may generate transaction data for one or more recurring transactions based on the profile characteristic configuration, which specifies a recurring transaction occurs until a specified date (e.g., until a date on which an account ‘cancellation’ occurs).

FIG. 5A is a graph 500 with a plurality of probability distributions 510-514 for determining a transaction amount, which may be used to generate the transaction data of one or more transactions, according to one implementation. The plurality of probability distributions 510-514 comprises an unadjusted probability distribution 510 (e.g., a base distribution as described above, with reference to the set of initial parameters 304 of FIG. 4) and a plurality of different adjusted probability distributions 511-514. Additionally, each of the different adjusted probability distributions may correspond to a different set of adjusted probability distributions and each different set of adjusted probability distributions may also comprise at least one adjusted probability distribution of possible transaction amounts for generating transaction data of one or more transactions. For example, a first set of adjusted probability distributions may comprise one of the adjusted probability distributions of possible transaction amounts (e.g., adjusted probability distribution 511) and a corresponding adjusted probability distribution of the for the possible number of transactions that may occur per day (e.g., adjusted probability distribution 521 shown in, and described with reference to, FIG. 5B).

FIG. 5B is a graph 501 of a plurality of probability distributions 520-524 for determining a number of transactions that may occur per unit of time (e.g., per day), which may be used to generate transaction data for one or more transactions, according to one implementation. The graph 501 illustrates an unadjusted probability distribution 520 (e.g., a base distribution as described above, with reference to the set of initial parameters 304 of FIG. 4) and a plurality of different adjusted probability distributions 521-524. Additionally, each of the different adjusted probability distributions 521-524 may correspond to a different set of adjusted probability distributions, according to one implementation. For example, adjusted probability distributions 511 (shown in FIG. 5A) and 521 may correspond to a first set of adjusted probability distributions, adjusted probability distributions 512 (shown in FIG. 5A) and 522 may correspond to a second set of adjusted probability distributions, adjusted probability distributions 513 (shown in FIG. 5A) and 523 may correspond to a third set of adjusted probability distributions, and so on.

In some embodiments, the adjusted probability distributions 514 and 524 may both correspond to a set of adjusted probability distributions that are adjusted according to a distribution modifier received by the data processing system for generating transaction data according to one or more events, such as an attrition event, according to one example. As can be seen in the graphs 500 and 501 of FIGS. 5A and 5B, the adjusted probability distributions 514 and 524 are each the probability distribution that is closest to zero along the horizontal axes of their respective graphs 500, 501. The adjusted probability distributions 514 and 524 may illustrate a set of adjusted probability distributions (e.g., a fourth set) that have been adjusted according to one or more distribution modifiers, as described with reference to method 230 (e.g., operations 232 and 234 illustrated in, and described with reference to, FIG. 2B). More specifically, the adjusted probability distributions 514 and 524 may illustrate a set of adjusted probability distributions that are adjusted according to one or more distribution modifiers associated with an attrition event according to one example, which may result in total transaction amount for the transactions by an entity (e.g., total amount per day) to decrease (e.g. approach zero) over time. As can be appreciated, in some embodiments, an attrition event may cause the total transaction amount for the transactions by an entity may decrease gradually over one or more transactions generated according to one or more sets of adjusted probability distributions. Alternatively, or in addition, one or more of the adjusted probability distributions 511-514 (shown in FIG. 5A) and/or one or more of the adjusted probability distributions 521-524 (shown in FIG. 5B) may likewise correspond to one or more sets of adjusted probability distributions that are adjusted according to a distribution modifier received by the data processing system for generating transaction data according to one or more events, as described above.

FIG. 6A is a graph 600 illustrating transaction data generated by the data processing system, according to one profile characteristic, more specifically, the number of transactions by an entity on each unit of time for which transaction data was generated by the data processing system (e.g., from January 2021 to January 2022), according to one implementation. The graph 600 illustrates the plurality of different start times (e.g., indicated by a dotted vertical line) 610, 611, 612, 613, and 614, which each correspond to a different set of profile characteristic configurations. In some embodiments, the data processing system may determine that the transaction data of all transactions occurring before a start time has been generated (e.g., determining that the transaction data has been generated for all transactions before start time 611). The data processing system may then use the set of profile characteristic configurations corresponding to the determined start time 611 (e.g., a first set of profile characteristic configurations), or the ‘active’ profile, to generate (or retrieve) a corresponding set of adjusted probability distributions that may be used to generate the transaction data for one or more subsequent transactions (e.g., one or more transactions occurring on, or after, start time 611). The data processing system may continue to use the active profile (e.g., the set of profile characteristic configurations corresponding to start time 611) to generate the transaction data of one or more transactions until it determines that it has generated all transaction data of the transactions occurring before the next start time (e.g., start time 612), at which point the data processing system may repeat the process with the corresponding set of profile characteristic configurations for each of the different start times 611, 612, 613, 614. For example, after determining that all transaction data of transactions before start time 612 has been generated, the data processing system may then use the corresponding set of profile characteristic configurations (e.g., a second set) to generate transaction data of any transactions occurring after the start time 612. As can be appreciated, each of the start times 611, 612, 613, and 614 may correspond to a change in the active profile, which may cause the data processing system to change from using one set of profile characteristic configurations (or an associated set of adjusted probability distributions) to using another different set of profile characteristic configurations (e.g., a new active profile) with a corresponding set of adjusted probability distributions. As described above, the data processing system may receive and/or access one or more distribution modifiers, which it may use to modify one or more sets of adjusted probability distributions and/or one or more corresponding sets of profile characteristic configurations. For example, the data processing system may receive a distribution modifier, which it may use to modify the active profile (or the corresponding set of adjusted probability distributions) from the start time 611 onward. For example the data processing system may use the received distribution modifier to adjust the sets of profile characteristic configurations of start times 611, 612, 613, and 614 to cause the total transaction amount per day to decrease upon each change in the active profile (e.g., at start times 612, 613, and 614).

FIG. 6B is a graph 601 illustrating transaction data generated by the data processing system, according to one profile characteristic—the total transaction amount per day—for the transaction data of one or more transactions by an entity and for each unit of time for which transaction data was generated (e.g., from January 2021 to January 2022), according to one implementation.

The graph 601 illustrates the plurality of different start times (e.g., indicated by a dotted vertical line) 610, 611, 612, 613, and 614, which may each correspond to a different set of profile characteristic configurations, as described above. In some embodiments, the data processing system may determine that the transaction data of all transactions occurring before a start time has been generated (e.g., determining that the transaction data has been generated for all transactions before start time 611). The data processing system may then use the set of profile characteristic configurations corresponding to the determined start time 611 (e.g., a first set of profile characteristic configurations), or the active profile, to generate and/or retrieve a corresponding set of adjusted probability distributions to generate transaction data of one or more subsequent transactions by that entity (e.g., to generate one or more transactions occurring on, or after, start time 611). The data processing system may continue to use the active profile (e.g., the set of profile characteristic configurations corresponding to start time 611) to generate the transaction data of one or more transactions until it determines that it has generated all transaction data of the transactions occurring before the next start time (e.g., start time 612), at which point the data processing system may repeat the process with the corresponding set of profile characteristic configurations for each of the different start times 611, 612, 613, 614. For example, after determining that all transaction data of the transactions before start time 612 has been generated, the data processing system may then use the corresponding set of profile characteristic configurations (e.g., a second set) for generating transaction data of one or more transactions occurring after start time 612. As can be appreciated, each of the start times 611, 612, 613, and 614 may correspond to a change in the active profile, which may cause the data processing system to change from using one set of profile characteristic configurations (or an associated set of adjusted probability distributions) to using another different set of profile characteristic configurations (e.g., a new active profile) with a corresponding set of adjusted probability distributions. As described already, the data processing system may generate one or more sets of adjusted probability distributions according to one or more distribution modifiers, in addition to the corresponding set of profile characteristic configurations. For example, the data processing system may receive a distribution modifier, which it may use to modify the active profile (or the corresponding set of adjusted probability distributions) from the start time 621 onward such that the total transaction amount (individually or in the aggregate) may always decrease with every change in the active profile of the data processing system (e.g., decreasing a limit on, or a maximum of, the total transaction amount per day, which occurs on each of the start times 222, 223, and 224). Additionally, the data processing system may generate a record that comprises the transaction data of one or more transactions, which was generated according to one or more distribution modifiers, by labelling the transaction data according to the corresponding one or more distribution modifiers used to generate that transaction data. Alternatively, or in addition, the data processing system may store one or more identifiers with the transaction data, which may identify one or more distribution modifiers with the corresponding one or more transactions generated by the data processing system (e.g., within the transaction data database 128 shown in, and described with reference to, FIG. 1).

At least one aspect of a technical solution to the aforementioned problem is directed to a method. The method may comprise generating, by a processor a plurality of probability distributions, each probability distribution corresponding to a different profile characteristic regarding transactions performed by an entity; receiving, by the processor, a first profile characteristic configuration for each of the plurality of probability distributions and a first start time; adjusting, by the processor, each of the plurality of probability distributions according to the first profile characteristic configuration for the probability distribution and the first start time to generate a first set of adjusted probability distributions; sampling, by the processor, each of the first set of adjusted probability distributions to generate transaction data for one or more first transactions; and training, by the processor based at least on the transaction data for the one or more first transactions, a machine learning model to generate account prediction values based on transaction data.

The method can further comprise receiving, by the processor, a second profile characteristic configuration for each of the plurality of probability distributions and a second start time, the second start time occurring after the first start time; adjusting, by the processor, each of the first set of adjusted plurality of probability distributions according to the corresponding second profile characteristic configuration and the second start time to generate a second set of adjusted probability distributions; and sampling, by the processor, each of the second set of adjusted probability distributions to generate transaction data for one or more second transactions. The method may comprise generating transaction data for any number of transactions (e.g., one or more third transactions, one or more fourth transactions, one or more fifth transactions) in this manner (e.g., using any number of profile characteristic configuration(s) with a corresponding number of start times and any number of set(s) of adjusted probability distributions). Stated differently, the method can comprise receiving any number of profile characteristic configurations for each of the plurality of probability distributions and receiving a corresponding number of start times (e.g., a number of start times equal to the number of received profile characteristic configurations and that each occur a period of time after the previous start time). The method can further comprise generating any number of adjusted probability distributions by adjusting a corresponding number of sets of adjusted plurality of probability distributions according to the corresponding profile characteristic configurations. Accordingly, the method can comprise sampling any number of adjusted probability distributions to generate transaction data.

Additionally, the method may comprise receiving, by the processor, a distribution modifier for each of one or more of the profile characteristic configurations; and wherein adjusting each of the first set of adjusted probability distributions comprises adjusting, by the processor, one or more of the first set of adjusted probability distributions corresponding to the one or more profile characteristic configurations according to the distribution modifiers to generate the second set of adjusted probability distributions.

At least one aspect of this technical solution is directed to a system. The system may comprise one or more hardware processors configured by machine-readable instructions to one or more processors configured by machine-readable instructions to generate a plurality of probability distributions, each probability distribution corresponding to a different profile characteristic regarding transactions performed by an entity; receive a first profile characteristic configuration for each of the plurality of probability distributions and a first start time; adjust each of the plurality of probability distributions according to the first profile characteristic configuration for the probability distribution and the first start time to generate a first set of adjusted probability distributions; sample each of the first set of adjusted probability distributions to generate transaction data for one or more first transactions; and train, based at least on the transaction data for the one or more first transactions, a machine learning model to generate account prediction values based on transaction data.

At least one aspect of this technical solution is directed to a non-transitory computer readable storage medium having instructions embodied thereon, the instructions being executable by one or more processors to perform a method. The method may comprise generating, by a processor a plurality of probability distributions, each probability distribution corresponding to a different profile characteristic regarding transactions performed by an entity; receiving, by the processor, a first profile characteristic configuration for each of the plurality of probability distributions and a first start time; adjusting, by the processor, each of the plurality of probability distributions according to the first profile characteristic configuration for the probability distribution and the first start time to generate a first set of adjusted probability distributions; sampling, by the processor, each of the first set of adjusted probability distributions to generate transaction data for one or more first transactions; and training, by the processor based at least on the transaction data for the one or more first transactions, a machine learning model to generate account prediction values based on transaction data.

These and other aspects and implementations are discussed in detail herein. The information and detailed description described herein include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, one or more data processing apparatuses and/or one or more data processing systems, as described herein. A computer storage medium can be, or be included in, a computer-readable storage device, a computer-readable storage substrate, a random or serial access memory array or device, or a combination of one or more of these. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the client device 102 and/or the transaction data engine 104) to perform actions by operating on input data and generating output. The processes and logic flows can also be performed by, and apparatuses can also be implemented as, special purpose logic circuitry, e.g., an FPGA (Field Programmable Gate Array) or an ASIC (Application Specific Integrated Circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method, comprising:
generating, by a processor, a plurality of probability distributions, each probability distribution corresponding to a different profile characteristic regarding transactions performed by an entity;
receiving, by the processor, a first profile characteristic configuration for each of the plurality of probability distributions and a first start time;
adjusting, by the processor, each of the plurality of probability distributions according to the first profile characteristic configuration for the probability distribution and the first start time to generate a first set of adjusted probability distributions;
sampling, by the processor, each of the first set of adjusted probability distributions to generate transaction data for one or more first transactions; and
generating, by the processor, a record comprising the generated transaction data.

2. The method of claim 1, further comprising:
training, by the processor based at least on the transaction data for the one or more first transactions, a machine learning model to generate account prediction values based on the generated transaction data.

3. The method of claim 1, further comprising:
receiving, by the processor, a second profile characteristic configuration for each of the plurality of probability distributions and a second start time, the second start time occurring after the first start time;
adjusting, by the processor, each of the first set of adjusted probability distributions according to the second profile characteristic configuration and the second start time to generate a second set of adjusted probability distributions; and
sampling, by the processor, each of the second set of adjusted probability distributions to generate transaction data for one or more second transactions.

4. The method of claim 3, further comprising:
receiving, by the processor, a distribution modifier for a profile characteristic,
wherein adjusting each of the first set of adjusted probability distributions comprises adjusting, by the processor, one or more of the first set of adjusted probability distributions corresponding to the profile characteristic of the distribution modifier to generate the second set of adjusted probability distributions.

5. The method of claim 4, further comprising:
identifying, by the processor, transaction data of one or more transactions corresponding to distribution modifier; and
generating, by the processor, a record comprising the identified transaction data of the one or more transactions and the corresponding one or more distribution modifiers.

6. The method of claim 3, wherein sampling each of the second set of adjusted probability distributions to generate the transaction data for the one or more second transactions comprises:
sampling, by the processor, each of the second set of adjusted probability distributions to generate the transaction data for the one or more second transactions to occur with a frequency that decreases to zero within a period of time beginning between the first start time and the second start time and ending a defined period of time after the second start time.

7. The method of claim 3 wherein training a machine learning model to generate account prediction values based on transaction data comprises:
generating, by the processor, a training data set from the transaction data for the one or more first transactions and the transaction data for the one or more second transactions;
labeling, by the processor, the training data set according to an identifier that corresponds to the second profile characteristic configuration; and
training, by the processor, the machine learning model according to the labeled training data set.

8. The method of claim 1, further comprising:
receiving, by the processor, a second profile characteristic configuration for each of the plurality of probability distributions and a second start time, the second start time occurring after the first start time;
adjusting, by the processor, each of the plurality of probability distributions according to the second profile characteristic configuration and the second start time to generate a second set of adjusted probability distributions; and
sampling, by the processor, each of the second set of adjusted probability distributions to generate transaction data for one or more second transactions.

9. The method of claim 1, further comprising:
identifying, by the processor, second transaction data for one or more second transactions corresponding to one or more profile characteristic configurations; and
generating, by the processor, a record comprising the identified second transaction data and the corresponding one or more profile characteristic configurations.

10. The method of claim 1, wherein sampling each of the first set of adjusted probability distributions comprises:
sampling, by the processor, each of the first set of adjusted probability distributions to generate transaction data comprising an amount, an identifier, and a location for one or more first transactions.

11. The method of claim 1, wherein sampling each of the first set of adjusted probability distributions comprises:
sampling, by the processor, each of the first set of adjusted probability distributions to generate transaction data for one or more recurring transactions.

12. A system comprising:
one or more processors configured by machine-readable instructions to:
generate a plurality of probability distributions, each probability distribution corresponding to a different profile characteristic regarding transactions performed by an entity;
receive a first profile characteristic configuration for each of the plurality of probability distributions and a first start time;
adjust each of the plurality of probability distributions according to the first profile characteristic configuration for the probability distribution and the first start time to generate a first set of adjusted probability distributions;
sample each of the first set of adjusted probability distributions to generate transaction data for one or more first transactions; and
train, based at least on the transaction data for the one or more first transactions, a machine learning model to generate account prediction values based on transaction data.

13. The system of claim 12, wherein the one or more processors are further configured to:
receive a second profile characteristic configuration for each of the plurality of probability distributions and a second start time, the second start time occurring after the first start time;
adjust each of the first set of adjusted probability distributions according to the second profile characteristic configuration and the second start time to generate a second set of adjusted probability distributions; and
sample each of the second set of adjusted probability distributions to generate transaction data for one or more second transactions.

14. The system of claim 13, wherein the one or more processors are further configured to:
receiving, by the processor, a distribution modifier for a profile characteristic,
wherein adjusting each of the first set of adjusted probability distributions comprises adjusting, by the processor, one or more of the first set of adjusted probability distributions corresponding to the profile characteristic of the distribution modifier to generate the second set of adjusted probability distributions.

15. The system of claim 14, wherein the one or more processors are further configured to:
identify transaction data of one or more transactions corresponding to distribution modifier; and
generate a record comprising the identified transaction data of the one or more transactions and the corresponding one or more distribution modifiers.

16. The system of claim 13, wherein the one or more processors are configured to sample each of the second set of adjusted probability distributions to generate the transaction data for the one or more second transactions by:
sampling each of the second set of adjusted probability distributions to generate the transaction data for the one or more second transactions to occur with a frequency that decreases to zero within a period of time beginning between the first start time and the second start time and ending a defined period of time after the second start time.

17. The system of claim 13 wherein the one or more processors are configured to train a machine learning model to generate account prediction values based on transaction data by:
generating a training data set from the transaction data for the one or more first transactions and the transaction data for the one or more second transactions;
labeling the training data set according to an identifier correspond to the second profile characteristic configuration; and
training the machine learning model according to the labeled training data set.

18. A non-transitory computer-readable storage medium having instructions embodied thereon, the instructions being executable by one or more processors to perform a method, the method comprising:
generating, a plurality of probability distributions, each probability distribution corresponding to a different profile characteristic regarding transactions performed by an entity;
receiving a first profile characteristic configuration for each of the plurality of probability distributions and a first start time;
adjusting each of the plurality of probability distributions according to the first profile characteristic configuration for the probability distribution and the first start time to generate a first set of adjusted probability distributions;
sampling each of the first set of adjusted probability distributions to generate transaction data for one or more first transactions; and
training, based at least on the transaction data for the one or more first transactions, a machine learning model to generate account prediction values based on transaction data.

19. The non-transitory computer-readable storage medium of claim 18, the method further comprising:
receiving a second profile characteristic configuration for each of the plurality of probability distributions and a second start time, the second start time occurring after the first start time;
adjusting each of the first set of adjusted probability distributions according to the second profile characteristic configuration and the second start time to generate a second set of adjusted probability distributions; and
sampling each of the second set of adjusted probability distributions to generate transaction data for one or more second transactions.

20. The non-transitory computer-readable storage medium of claim 19, the method further comprising:
receiving a distribution modifier for a profile characteristic,
wherein adjusting each of the first set of adjusted probability distributions comprises adjusting one or more of the first set of adjusted probability distributions corresponding to the profile characteristic of the distribution modifier to generate the second set of adjusted probability distributions.
